(19) United States
(12) Patent Application Publication
(10) Pub. No.: US 2016/0025480 A1
(43) Pub. Date: Jan. 28, 2016

(54) INTERFEROMETRIC LEVEL SENSOR

(71) Applicant: NIKON CORPORATION, Tokyo (JP)

(72) Inventors: Eric Peter Goodwin, Tucson, AZ (US); Daniel Gene Smith, Tucson, AZ (US)

(21) Appl. No.: 14/808,197

(22) Filed: Jul. 24, 2015

Related U.S. Application Data
(60) Provisional application No. 62/029,113, filed on Jul. 25, 2014.

(51) Int. Cl. G01B 11/06; G01B 9/02; G01B 11/14

(52) U.S. Cl. CPC G01B 11/06; G01B 11/14; G01B 9/02028

(57) ABSTRACT

Interferometer system and method for use in a level sensor of an exposure apparatus and autofocus system employing same. Operating either at a single or multiple wavelengths, the interferometric system employs two diffraction orders, formed by diffraction grating of the system, as reference and sample beams and is structured to ensure that only light contained in one of the two orders interacts with a wafer under test, thereby ensuring that no interference fringes are projected onto the sample. The diffraction grating is positioned such that its grooves are nominally perpendicular to the direction of wafer scan. Based on measurement data representing interference between reference and sample beams at the detector, a determination of change in position of the wafer in the sample arm is made with increased sensitivity and/or resolution.

### CROSS-REFERENCE TO RELATED APPLICATIONS

The present patent application claims priority from the U.S. Provisional Patent Application No. 62/029,113 filed on Jul. 25, 2014 and titled “Interferometric Level Sensor”. The disclosure of this provisional patent application is incorporated herein by reference in its entirety.

### TECHNICAL FIELD

The present invention relates to a lithographic apparatus and, more particularly, to a system for measuring a position of a wafer positioned in a lithographic apparatus for lithographic exposure.

### BACKGROUND

In order to transfer images from a reticle onto a semiconductor wafer during semiconductor wafer processing, exposure apparatus are commonly used. A typical exposure apparatus, used for transfer of a pattern from a reticle onto a substrate of interest (interchangeably—a target substrate or a wafer, such as a semiconductor wafer during the semiconductor processing) includes an illumination source, a reticle stage assembly (that positions a reticle), an optical assembly containing projecting optics, and a wafer stage assembly (that positions the target substrate or a wafer). The exposure apparatus also includes a measurement system (that monitors positions of the reticle and the target substrate), and a control system that governs operations of assemblies to adjust, when required, mutual positioning of the reticle and the target substrate. The geometrical features of patterns transferred from the reticle onto the target substrate are extremely small, which imposes extremely tight requirements on precise positioning of the target substrate and the reticle to manufacture high quality patterned semiconductor wafers.

In certain exposure apparatus, the measurement system includes an autofocus system (or AFS) that is used to map the topography of the wafer surface along the optical axis prior to exposing the wafer to a pattern-forming illumination. To effectuate this operation, the AFS employs one or more sensors to collect data used to control, mechanically or electromechanically, the adjustment of focus of the optical system or, alternatively the working distance at which the identified element of the optical system should be positioned with respect to the target during the operation. Subsequently, with the use of data representing position(s) of the wafer along the optical axis, the wafer stage assembly can be controlled to properly position the wafer along the optical axis.

When used in lithographic equipment, an AFS is often employed to maintain the identified target surface (associated with the semiconductor wafer) in focus of the optical system during the exposure procedure, and/or to map the wafer topography. Based on the mapped topography, the orientation of the wafer is defined during the exposure process. Such AF-operation typically relies on the use of i) measurement beam(s), incident on and reflected by the wafer at large angles relative to the axis that is perpendicular to the wafer (a so-called wafer normal), which is required to achieve high sensitivity of the AFS to changes in height of the wafer's target surface; and (ii) a reference beam of light that is bounced or reflected from a reference surface or mirror positioned along the target surface that is subject to measurement. The optical paths that beam(s) of light (used for the measurement of the profile of the target surface) and a reference beam follow through the system are substantially long, as defined by the practical configuration of a typical AF system. Such optical paths, therefore, are inevitably subject to various measurement errors caused by, for example, environmental changes (such as air turbulence, slowly moving air; atmospheric pressure, and/or humidity changes or gradient). In practice, the effect of such environmental changes is difficult and costly to eliminate. In addition, instabilities in the autofocus system itself (such as, for example, mechanical instabilities in the vibrating mirrors, optics, and/or other components), Goos-Hanchen shift (phase shift acquired by a beam upon reflection off of the wafer), the presence of a pattern on the target surface of the wafer—all these can adversely influence the accuracy of the AFS and ultimately the accuracy with which the position of the wafer along the optical axis is determined.

The ubiquity of such errors, the measure of spatial value of which is becoming comparable to the range of required focus correction as the accuracy and precision of the AF modalities continue to increase, begs a question of whether it is possible to compensate for or negate such measurement errors with the use of a differently-structured autofocus system and measurement approach, and, preferably, without making the costly and impractical attempts to eliminate the changes in the environmental ambient.

Accordingly, there is a need for an autofocus system that has low susceptibility to instabilities in the autofocus system and environmental conditions.

### SUMMARY

An embodiment of the present invention provides an autofocus system (AFS) comprising an interferometer the sample and reference arms of which correspond, respectively, to optical paths of sample and reference beams of light. The autofocus system is structured such that he sample beam of light includes only light contained in one order of diffraction of light incident onto a diffraction grating of the AFS, while the reference beam of light includes only by light contained in another order of diffraction of said light incident on said diffraction grating.

An embodiment of the invention additionally provides an AFS comprising an interferometer, which includes a sample arm and a reference arm. Each arm of the interferometer has a corresponding first end defined by a diffraction grating in such a fashion as to direct only first light that is contained in one diffraction order beam (formed by the diffraction grating in response to light incident thereon) into the sample arm, and to direct only second light that is contained in another diffraction order beam (formed by said diffraction grating in response to said light incident thereon) into the reference arm.

An embodiment of the invention also provides a method for operation of an AFS. The method includes (i) forming first and second optical beams as a result of diffraction of light incident onto a diffraction grating; (ii0 transmitting only the first optical beam through a sample arm of the interferometer disposed within the AFS to form a sample optical beam; (iii) transmitting only the second optical beam through a reference arm of the interferometer to form reference optical beam; and (iv) forming interference fringes by overlapping the sample and reference beams at an optical detector of the AFS.

### BRIEF DESCRIPTION OF THE DRAWINGS

The invention will be more fully understood by referring to the following Detailed Description in conjunction with the generally not-to-scale Drawings, of which:

FIG. 1 is a diagram illustrating an exposure apparatus;

FIGS. 2A and 2B show schematically an embodiment of a fringe-projection system of an exposure apparatus, in side view, and orientation of a diffraction grating in such fringe-projection system;

FIG. 2C is a schematic illustrating fringe-shifting caused by change in height profile of an object under test in a fringe-projection system;

FIGS. 2D and 2E illustrate a portion of a fringe-projection system in front and top views, respectively;

FIG. 2F provides another illustration of a fringe-projection-based autofocus system of related art;

FIGS. 3A, 3B, and 3C are side, top, and front views of an interferometric focusing arrangement according to an embodiment of the invention;

FIG. 4A schematically illustrates an embodiment of an autofocusing system employing the interferometric arrangement of FIG. 3A, for use in an exposure apparatus;

FIG. 4B illustrates, in top view, separation of light of diffraction orders with respect to a portion of the interferometric arrangement of FIG. 3B;

FIG. 4C is a diagram showing spatial orientation of a diffraction grating in the embodiment of FIG. 4A;

FIG. 4D is a diagram illustrating an embodiment of a multi-faceted reflector structured for use with an autofocusing system of the invention;

FIG. 4E is a diagram illustrating another embodiment of a multi-faceted reflector structured for use with an autofocusing system of the invention;

FIG. 4F is a side view of a receiving side of an autofocusing system that employs a multi-faceted reflector, according to an embodiment of the invention;

FIGS. 4G and 4H show specific embodiments of spatial filters employed, respectively, at the sending and receiving sides of the system of the invention;

FIG. 5 is a simplified diagram showing, in top view, an interferometric system employing a spatial filter configured as a prism, for use in an autofocusing system according to an embodiment of the present invention;

FIG. 6 a plot illustrating angles of incidence of light onto a wafer positioned in an embodiment of the invention, as a function of wavelength to realize equal spatial shifting for interference fringes formed at these wavelengths;

FIG. 7 is a schematic diagram of the sending portion of an embodiment of the invention configured for operation with a polychromatic source of light.

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

Photolithography is a process commonly used in defining features during semiconductor wafer processing, such as used in the fabrication of integrated circuits (ICs). Photolithography generally involves applying a photoresist material (e.g., resist) to a wafer, exposing the resist using a pattern of applied radiation (e.g., light), developing the resist, etching a material of the wafer through the patterned resist, and removing the resist after etching. In photolithography, a critical dimension (CD) is a characteristic length that corresponds to various features critical to the IC performance that needs to be patterned on the surface, e.g., a minimum feature width and/or a minimum spacing between features. Control of both CD and positioning of various lithographic patterns is an important aspect of the lithography process to ensure that the end product meets the design specification. Such control often requires a precise definition of a profile of a given surface as a function of time and/or position, or a detailed mapping of the spatial features associated with such surface and, therefore, an ability to precisely measure a position of the wafer in the lithographic apparatus.

The need to define topography of a surface of a sample-under-test (SUT) such as a substrate of chosen material (a semiconductor wafer, for example) with resolution, along an axis normal to such surface, and accuracy that are higher than those characterizing a fringe-projection AFS is solved by structuring an AFS employing a diffraction grating as an interferometric system, in which light corresponding to one diffraction order produced by the grating forms a sample (or measurement) beam that interacts with the SUT but not with a reference mirror of the AFS, while light corresponding to another diffraction order forms a reference beam that interacts only with the reference mirror but not the SUT. Such interferometric AFS is configured to make the sample and reference beams interfere on a surface of the optical detector, of the detector assembly, that is configured as an optical conjugate of the diffraction grating of the AFS.

The problem of increasing the axial resolution of measurement of a relief features and configuration(s) of a surface of an SUT is solved by employing an interferometer device as part of the AFS, in which interferometer the diffraction grating employed by the AFS is configured as a beam-splitter, which defines a first ends of both the sample and reference arms of the interferometer device and which redirects a sample beam (defined by one order of diffraction of light incident onto the grating) towards the working surface of a work piece (for example, a target surface of the subject under test such as a wafer) that is being spatially mapped. Such beam-splitter additionally redirects a reference beam (defined by another order of diffraction of light incident onto the grating) away from the sample beam and towards the reference mirror of the AFS. The second ends of both the sample and reference arms is defined by an optical detector of the AFS, which is configured to provide a tangible surface on which the combined sample and reference beams form interference fringes based on which a change in the axial position of the working piece is further determined.

In order to better understand the features of the present invention, general overviews of the exposure apparatus and a fringe-projection AFS (FP-AFS) used by the related in an exposure apparatus are first provided.

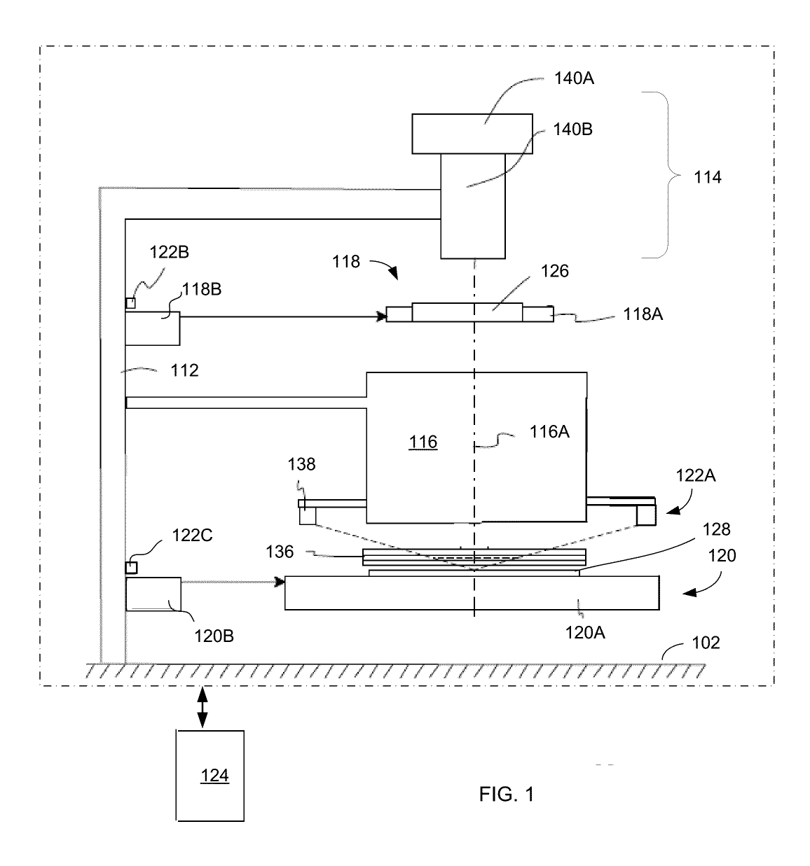

Exposure Apparatus. An example of an exposure apparatus (also interchangeably referred to as a lithographic apparatus), which may employ an AFS for measurements of wafer displacements is provided, for example, in PCT/US2012/043186, which is incorporated herein by reference. FIG. 1 schematically illustrates, in reference to the provided Cartesian system of coordinates, a schematic illustration of such exposure apparatus.

The exposure apparatus 100 includes an apparatus frame 112, an illumination system 114 (also referred to as irradiation apparatus), an optical assembly 116, a reticle stage assembly 118, a wafer stage assembly 120, a positioning system (shown as a combination of several units including systems 122A, 122B, 122C), and a control system 124. The design of the components of the exposure apparatus 100 can be varied to suit specific requirements. The exposure apparatus 100 may be mounted to/on a mounting base 102, such as the ground, a base, or floor, or some other supporting structure.

Apparatus Frame. The apparatus frame 112 is rigid and supports and/or houses at least the reticle stage assembly 118, the optical assembly 116, the wafer stage assembly 120, and the illumination system 114 above the mounting base 102.

Illumination System. The illumination system 114 includes an illumination source 140A and an illumination optical assembly 140B. The illumination source 140A emits radiation to which the wafer/work-piece 128 is exposed and which is guided by the illumination optics of the assembly 140B to the optical assembly 116, along an optical axis 116A. On its way to the optical assembly 116, the beam of radiation illuminates a portion of the reticle 126 to gain spatial pattern of irradiation representing the pattern of the reticle 126.

The illumination source 140A can be, for example, any of a g-line source (436 nm), an i-line source (365 nm), a KrF excimer laser (248 nm), an ArF excimer laser (193 nm), a F2 laser (157 nm), or an EUV source (13.5 nm). The wafer-illuminating (exposure) light may be provided at about 193 nm (by an ArF excimer laser system, for example) light (with a wavelength of 193 nm), but it can also include ultraviolet light such as described in, for example, U.S. Pat. No. 7,023,610. The source 140A of illuminating light may exploit harmonic frequency conversion or utilize an optical-fiber based amplifier, to produce radiation at a predetermined wavelength. Alternatively, the illumination source 140A can generate charged particle beams such as an x-ray or an electron beam. For instance, in the case where an electron beam is used, thermionic emission type lanthanum hexaboride (LaB6) or tantalum (Ta) can be used as a cathode for an electron gun. Furthermore, in the case where an electron beam is used, the structure could be such that either a mask is used or a pattern can be directly formed on a substrate without the use of a mask.

Optical Assembly. The optical assembly 116 projects and/or focuses the light passing through the reticle 126 onto the work piece (wafer) 128. Depending upon the design of the exposure apparatus 100, the optical assembly 116 can scale (i.e., to magnify or reduce, with a specific coefficient) dimensions of the pattern of the reticle 126. In a specific implementation, the optical assembly 126 may simply relay the pattern of the reticle 126 onto the wafer (i.e., have a unit magnification).

Reticle Stage Assembly. The reticle stage assembly 118 holds and positions, (with the use of a reticle stage mover assembly 118B) the reticle stage 118A that retains the reticle 126 relative to the optical assembly 116 and the wafer 128. The reticle stage mover assembly 118B can be designed to move the reticle stage 118A along any of the x, y, z axes.

Wafer Stage Assembly. The wafer stage assembly 120 holds and positions (with the use of a wafer stage mover 120B) the wafer 128 with respect to the image of the illuminated portion of the reticle 126 projected onto the wafer. The wafer stage mover 120B can be designed to move the wafer 128 along any of the x, y, z axis. In one embodiment, the wafer 128 can be scanned while the wafer stage assembly 120 moves the wafer 128 along the y-axis.

Positioning System. The positioning system (122A, 122B, 122C) monitors movement of the reticle 126 and the wafer 128 relative to the optical assembly 116 or some other reference. As shown in FIG. 1, the position system 122 includes (i) an AFS 122A that maps the topography of the wafer 128 relative to the optical assembly 116 along the Z axis (which is collinear with the optical axis 116A), about the X axis, and about the Y axis prior to exposure of the wafer with improved accuracy; (ii) a reticle measurement system 122B (only a portion of which is illustrated) that monitors the position of the reticle stage 118A and the reticle 126; and (iii) a wafer measurement system 122C (only a portion of which is illustrated) that monitors the position of the wafer stage 120A along the X and Y axes, and about the Z axis. Due to operation of the position system, the wafer stage assembly 120 can be controlled to position the wafer 128 with improved accuracy. The positioning system 122 can utilize laser interferometers, encoders, autofocus systems, and/or other measuring devices.

One known implementation the autofocus system 122A includes a reference system 136 providing a reference signal used in conjunction with and related to the measurement of any changing operational parameter of the AFS 122A but not the position of the wafer 128 along the optical axis 116A. The AFS 122A further includes a measurement system 138, which provides a measurement signal used in conjunction with and related to the measurement of anything changing in the AFS 22A including (the change of, if present,) position of the wafer 128 along the optical axis 116A. By comparing the reference and measurement signals, the position of the wafer 128 is measured, which is accompanied with reduction of the stability requirements for many of the components of the AFS 122A.

A typical measurement system 138 may include an encoder assembly (not shown) that measures, in operation, the position of a work piece (as shown—the wafer 128). For example, in some embodiments, the encoder assembly can be designed to monitor and/or measure the position of the work piece along two axes (e.g., along the x- and y-axes). Additionally and/or alternatively, the encoder assembly can be designed to measure and/or monitor the position of the work piece 128 along all three axes (i.e., to specify the 3D position of the work piece 228).

The conventional measurement system 138 may also includes a stage grating (not shown) that is secured to a side of the wafer stage 120A (of the assembly 120) that retains the work piece 128, and one or more fixed encoder heads (not shown). The number of encoder heads and their mutual positioning and orientation can be varied according to the design of the exposure apparatus 100 and/or the measurement system 138, and the amount of travel of the stage 120A along x- and y-axes. The use of multiple encoder heads enables the encoder assembly to more accurately measure the position of the stage 120A, and thus the position of the work piece 128 that is retained by the stage 120A. Examples of the structure(s) of the measurement system 138 and encoder head(s) are discussed in detail in U.S. 2014/0049762, which is incorporated herein by reference, and will not be addressed here additionally.

Control System. The control system 124 is operably connected to and governs the operation of at least the illumination system 114, the reticle stage assembly 118, the wafer stage assembly 120, and the positioning system 122. The control system 124 acquires measurement data, from the positioning system 122, that represent position and/or orientation and/or movement of the reticle 126 and/or wafer 128 with respect to the optical assembly 116 or another chosen reference. Based on these data, the control system 124 controls the assemblies 118, 120 to precisely position the reticle 126 and the wafer 128. The control system 124 can include one or more processors and electronic circuits, at least one of which may be specifically programmed to perform steps of data acquisition, data processing, and control of operation of the components of the apparatus 100.

Generally, the exposure apparatus 100 can be used as a scanning type photolithography system for optical transfer of a spatial pattern from the reticle 126 onto the wafer 128, with the reticle 226 and the wafer 228 moving synchronously. Alternatively, the exposure apparatus 120 can be used as a step-and-repeat type photolithography system that exposes the reticle 126 while the reticle 126 and the wafer 128 are stationary. The use of the exposure apparatus 100, however, is not limited to a photolithography system for semiconductor manufacturing and can include, as a non-limiting example, the use as an LCD photolithography system that projects a liquid crystal display device pattern onto a rectangular glass plate or a photolithography system for manufacturing of a thin film magnetic head.

Fringe-Projection AFS. As is understood by a skilled artisan, the principle of operation of a fringe-projection AFS (FP AFS) used in related art as part of the exposure apparatus is based on projecting (imaging of) a chosen irradiance pattern formed with the use of the diffraction grating onto the target surface under test (for example, a surface of a semiconductor wafer being measured) and the following re-imaging an fringe pattern formed on the surface onto an plane of the optical detector. Such imaging and re-imaging facilitate the determination of both the initial (or nominal) position of the surface and its new position (for example that resulting from the movement of the surface along a line normal to its surface) based on changes of the fringe-pattern formed on the optical detector, which is optically conjugate with the surface of the wafer.

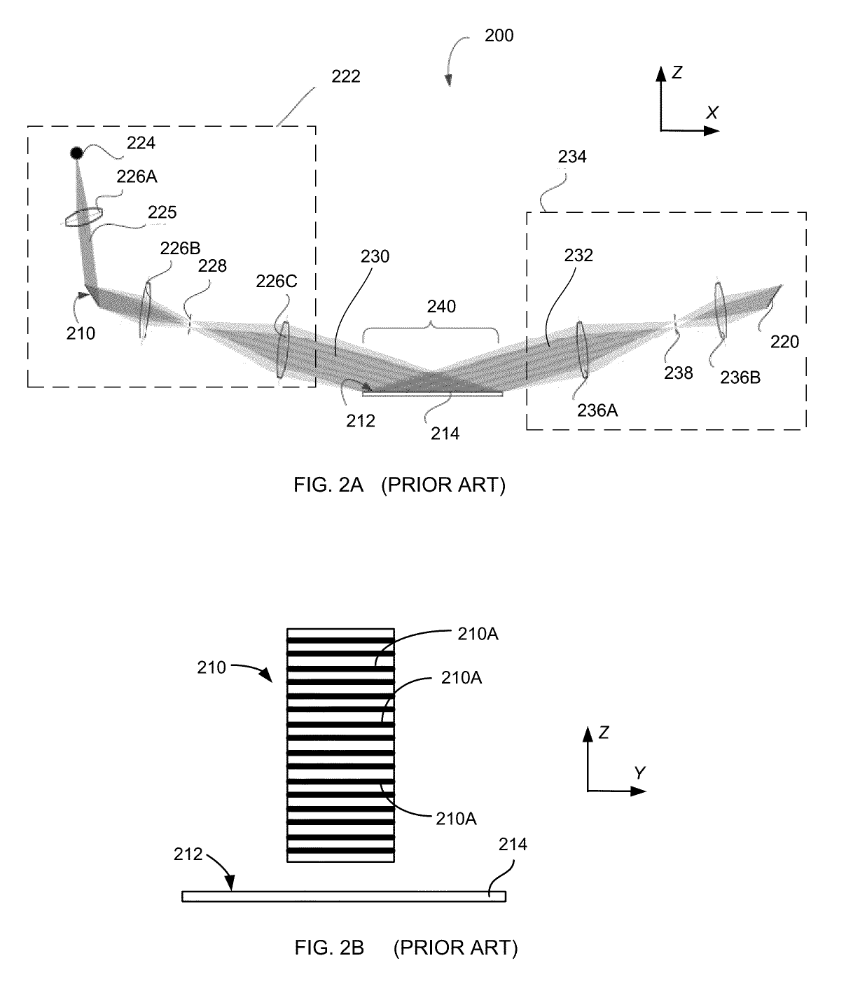

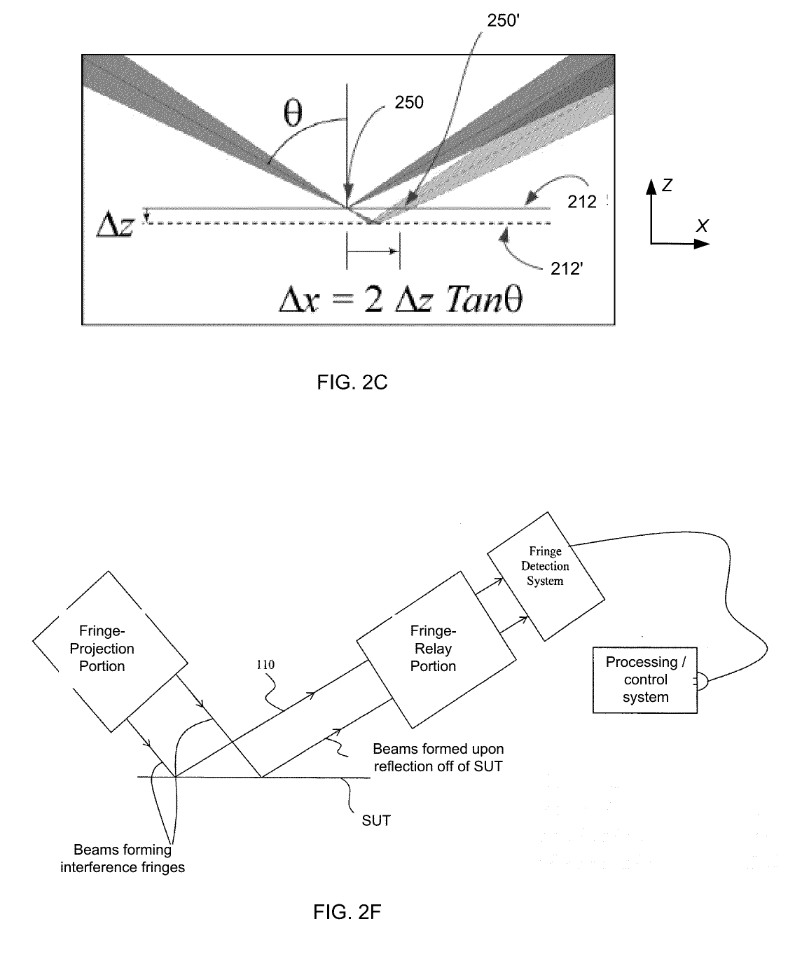

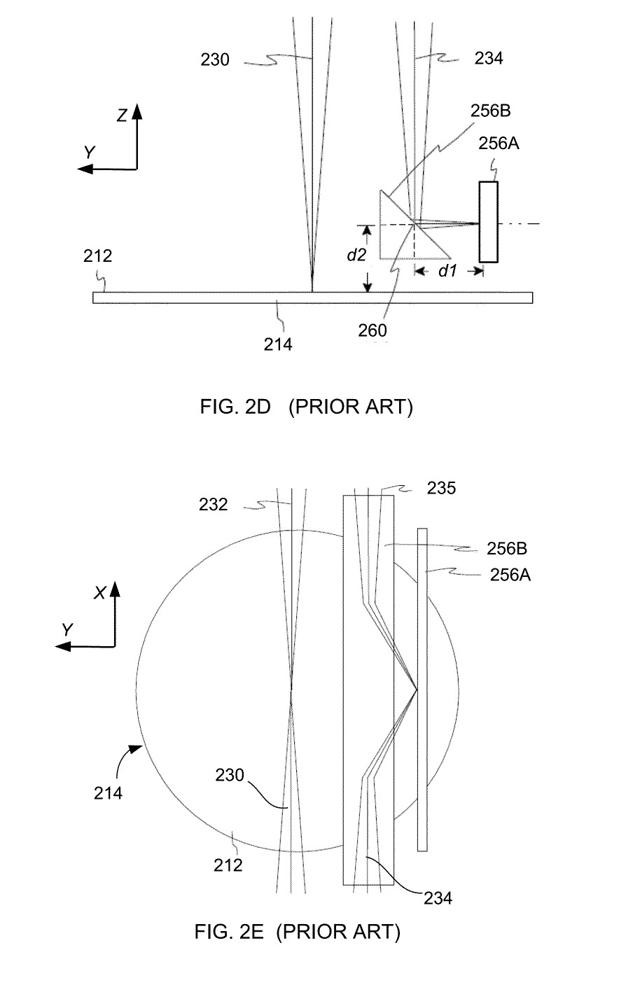

FIG. 2A provides a schematic illustration of the principle of operation of a fringe-projection sub-system 200 employing a diffraction grating 210 and used in an optical autofocus system of related art. The sub-system 200 is configured to project an irradiance pattern formed with the use of the grating 210 onto the target surface 212 of the substrate 214 using a fringe-generating (or source) portion of the system 200, and to re-image this pattern from the surface 212 onto the plane of the detector 220 using the detection (or receiving) portion of the system 220. Each of the grooves 210A of the grating 210 is substantially parallel to the surface 212 (shown as the xy-plane in FIG. 2B). A simplified optical train of the fringe-projection sub-system includes a fringe-generating portion (or a source portion) 222 typically containing a multi-wavelength (for example, broad-band) source of light 224 that produces the illuminating light 225. The optical train additionally includes the grating 210; auxiliary optics such as lenses 226A, 226B; and a spatial filter 228 (which, in some cases, may include a mirror). The optics of the portion 222 aggregately produces the irradiance pattern such as, for example, the substantially sinusoidal irradiance pattern optically projected from grating 210 onto the surface 212. The optical train also includes a receiving (or fringe-relay portion) 234 that is optically coupled with the source portion 222 through the substrate 214 (as well as through the reference mirror of the AFS, not shown here) and that redirects light reflected by the substrate 214 to the detector 220. The spatial filter 228 blocks the zeroth diffraction order of light distribution formed, in reflection, by the grating 210 and passes, at the same time, only the +1 and −1 orders (labeled collectively as 230) towards the substrate 214. The projection of fringes onto the plane of the detector 220 (with light beam(s) 232) produces an overlap of two off-axis plane waves (respectively corresponding to +1 and −1 orders of diffraction of light at the grating 210) on the plane of the detector and represents the imaging of the sinusoidal grating 210 onto the detector 220 with a portion of the sub-system 200. Considering that the orientation of the grooves 210A of the diffraction grating 210 is along a line that is substantially parallel to the surface 212 of the wafer 214, fringes formed on the optical detector are also extended along the surface 212 of the wafer 214.

When the grating 210 is imaged onto the surface 212 with a combination of optics forming an afocal optical relay of the sending portion of the system 200, a fringe pattern 240 formed on the surface 212 has the same spatial frequency regardless of the wavelength of light generated by the source 224, while plane waves arriving at the surface 212 from the lens 226C at different wavelengths are incident onto the surface at different angles.

The irradiance fringe(s) that have been re-imaged onto the plane of the detector 220—with the use of the receiving portion of the system 200 that includes reimaging optics 236A, 236B, 238 (which may be configured as a spatial filter, optionally including a reflecting surface) and, optionally, additional optical elements—are used for the determination of the initial or nominal position and re-positioning of the surface 212 (with respect to the z-direction, defined as a direction along a normal to the surface 212). If and when the surface 212 moves along the z-axis by Δz and assumes a new position 212′ (or, alternatively, when the profile or local height of the surface 212 changes, which produces the same results), as is schematically shown in FIG. 2C, a fringe 250 from the fringe pattern 240 is shifted laterally (from 250 to 250′) in the same nominal plane by the distance Δx that is generally a function of Δz and the angle θ of incidence of light onto the surface 212. The output from the photodetector 220 (a position of which is defined by an optical conjugate of the nominal position of the surface 212) is used to determine the z-axis adjustments and corresponding focus adjustments required to keep the surface 212 at the optical focus of the system. In reference to FIGS. 2D and 2E, portions of each of diffraction orders forming the fringe pattern 240 one the surface 212 can be redirected, as beam(s) 234, from the grating 210 to a reference reflector 256A (interchangeably referred to herein as a reference mirror and disposed in proximity to the substrate 214 as shown) to form a reference signal 235 further forwarded to an optical detector. The redirection of the beam(s) 234 can be facilitated by the use of a reflector the optical surface of which 260 is tilted with respect to the surface 212. In other words, the optical system of the FP-AFS of the related art is structured such as to have both beams that propagate through the optical trains of the FP-AFS (the measurement beam 230 forming fringes on the SUT and the reference beam 234 bouncing off the reference mirror) carry light contained in the same diffraction order beam formed by the grating 210.

In a related embodiment, the FP-AFS may utilize two diffraction gratings on the sending side. Here, these diffraction gratings are displaced with respect to one another in a direction perpendicular to the direction of wafer scan such that one fringe pattern is projected onto the wafer and another fringe pattern (offset along a direction of wafer scan with respect to the first pattern) is projected onto the reference mirror. Additional details of embodiments of a typical fringe projection AF system and its operation in the exposure apparatus can be found in, for example, commonly assigned U.S. Patent Application Publications 2011/0071784 and 2012/0008150, as well as the patent application publication WO 2012/177663, the disclosure of each of which is incorporated herein by reference. FIG. 2F provides another schematic illustration of the FP-AFS used in the related art (where the fringe-projection portion is shown to include the diffraction grating of the AFS.)

It is understood that an AFS 200 utilizing a fringe-projection portion of the FP-AFS is structured such that light at any wavelength from the source 224 impinges on the same diffraction grating 210 at the same incident angle, and that the z-dependent profiling of the target surface 212 may be carried out based on the measurements performed at at least two different wavelengths. As has been already alluded to above, the spatial shift of a fringe pattern 240 along the surface 212′ (as compared to the position of a fringe pattern on a nominally located surface 212) and a corresponding shift of the image of this fringe pattern on the plane of the detector 220 are generally caused not only by the change of profile (or movement) of the surface under test along the z-axis, but also by the change in index of refraction of the medium (such as air) through which light, which forms the fringe pattern, arrives at the surface 212, as well as by Goos-Hanchen shift.

### EXAMPLES OF EMBODIMENTS OF THE INVENTION

### Example 1

Embodiments of the present invention address a system that includes an optical interferometer sub-system and that is configured as a level sensor for determining a height of a work piece (such as a substrate) with the use of one or more measurement beams that are formed by the sensor and directed to the work piece through a sample arm of the interferometer and also with the use of one or more reference beams. Just like the measurement beam(s), the reference beams are also formed by the sensor and directed to the reference reflector through a reference arm of the interferometer. A programmable processor, that receives data representing interference between the measurement and reference beams on the optical detector assembly (including an optical detector and, if appropriate, optical spectral and/or polarizing filters), is specifically programmed to introduce a correction into the measurement signal based on a reference signal to form a map of the height of the surface accounting for such a correction. The optical arrangement of the interferometric system is such that no light from the reference beam comes in contact with the substrate. In one embodiment, the optical path difference between the sample and reference arms of the interferometer is maintained within the coherence length of a light-generating source.

In stark contradistinction with the related art, embodiments of the present invention do not require that light, which is contained in a beam formed by a beam-splitting component in the sending portion of the AFS, be present both in a beam incident onto the work piece (SUT) placed into the exposure apparatus and a beam incident onto the reference mirror. Moreover, the present invention stems from the realization that the axial resolution sensitivity of the measurement of the SUT (i.e., the sensitivity of the resolution of determining the height of the wafer) will be advantageously increased when two conditions are satisfied: when (i) the SUT is positioned internally into a sample arm to provide an optical path only for the first of two beams formed by the beam-splitting component of the sending portion of the AFS, while (ii) a reference arm of the interferometer includes a reference mirror of the AFS and provides an optical path only for the second of the two beams formed by the beam-splitting component of the sending portion of the AFS. It is understood that, in so structuring an embodiment of the invention, no light from the first beam is directed through the reference arm and no light from the second beam is directed through the sample arm. As a result (and contrary to the operation of an AFS system of the related art), no projection of interference fringes occurs, in operation, onto the SUT, and no interference of light happens at the SUT. Rather, the sample and reference beams of an embodiment of the invention are configured to form interference fringes only on a surface of the optical detector of the detection unit, to acquire measurement data representing such interference fringes. Based on such measurement data, a determination of a change of a position of the SUT in the sample arm of the interferometer of the embodiment is made with a specifically programmed electronic circuitry (such as a computer processor, for example). For the simplicity of referencing and illustration, an embodiment of the present invention is further referred to as an interferometric focusing system, or IAF.

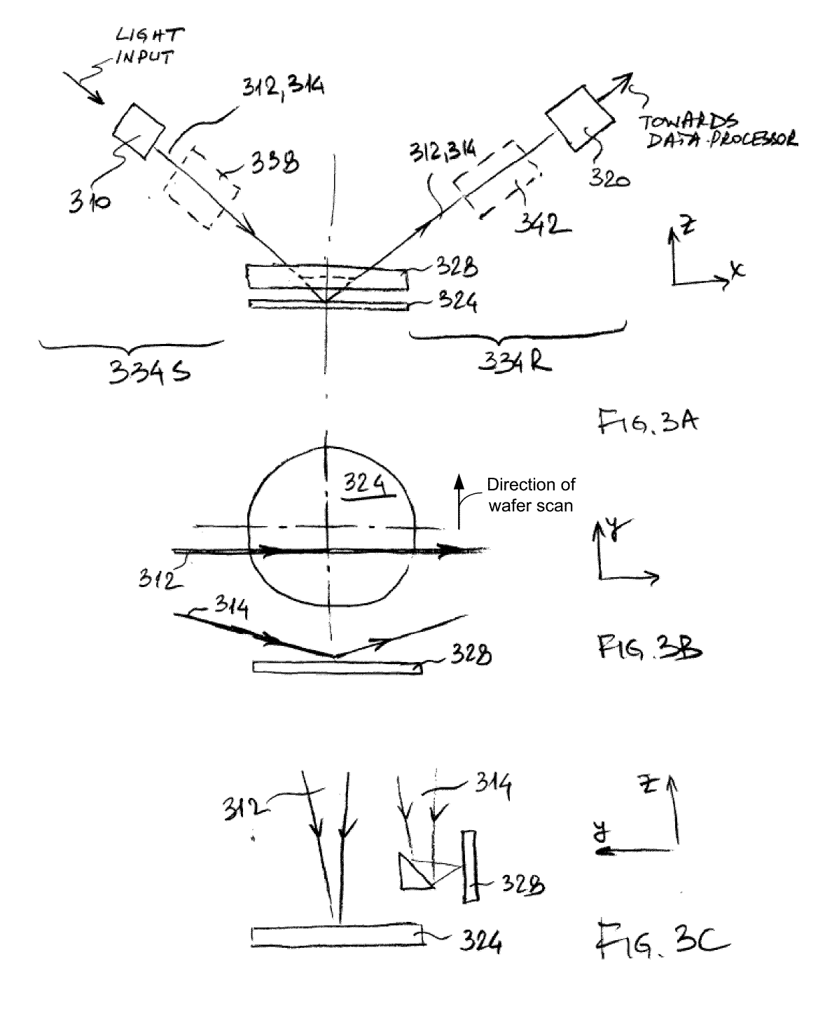

FIGS. 3A, 3B, and 3C provide an example of an interferometer portion 300 of an embodiment of the IAF. Here, the interferometer 300 is defined, on one end, by the beamsplitter 310 (that forms a sample beam 312, also interchangeably referred to as a measurement beam, and a reference beam 314) and a surface of a beam combiner 320 at which the sample and reference beams 312, 314 interfere to form optically detectable interference fringes. After having been spatially deviated from the reference beam 314, the sample beam 312 propagates along an optical path of the sample arm of the interferometer 300, which is spatially distinct and different from the reference arm of the interferometer 300. The sample and reference arms intersect each other only at two locations: at the beamsplitter 310 and the beam combiner 320. Therefore, the light beams overlap and interfere only at a surface of the beam combiner 320. In operation, the SUT 324 is placed across the sample beam 312, while the reference beam 314 is appropriately directed (for example, in a fashion discussed in WO 2012/177663 and similar to that schematically shown in FIGS. 2D, 2E) to interact with the reference reflector 328 of the IAF. Portions of the sample and reference arms of the interferometer 300 that precede the SUT 324 and the reference reflector 328 are parts of the sending side or portion 334S of the IAF. Those portions of the sample and reference arms of the interferometer 300 that are structured to collect light (in either the sample beam 312 or the reference beam 314) and deliver it to form interference fringes at the beam combiner 320 are included into a receiving side or portion 334R of the IAF. Auxiliary beam-shaping optical component(s) 338, 342 (such as, for example, lenses, spatial filters, reflectors) can be utilized in any of the sending and receiving portions of the IAF, and can be positioned either within an arm of the interferometer 300 (as shown) or outside of the interferometer (for example, across an input beam of light incident onto the beamsplitter 310).

The surface of the beam combiner 320 is positioned to be an optical conjugate of a surface of the beamsplitter 310 and, in a specific case, an optical conjugate of a foot-print formed by the sample beam 312 on the SUT 324 placed in the interferometer 300 for measurement. It is appreciated that, generally, it is not required that the sample beam 312 be collimated when it is incident onto either the SUT 324 or the beam combiner 320. Similarly, generally it is not required that the reference beam 314 be collimated when it is incident onto either the SUT 324 or and beam combiner 320. This manifests yet another structural distinction of an embodiment of the present invention from an AFS of the related art. However, in a specific configuration, the beam-shaping optics 338, 342 may be configured to ensure such collimation.

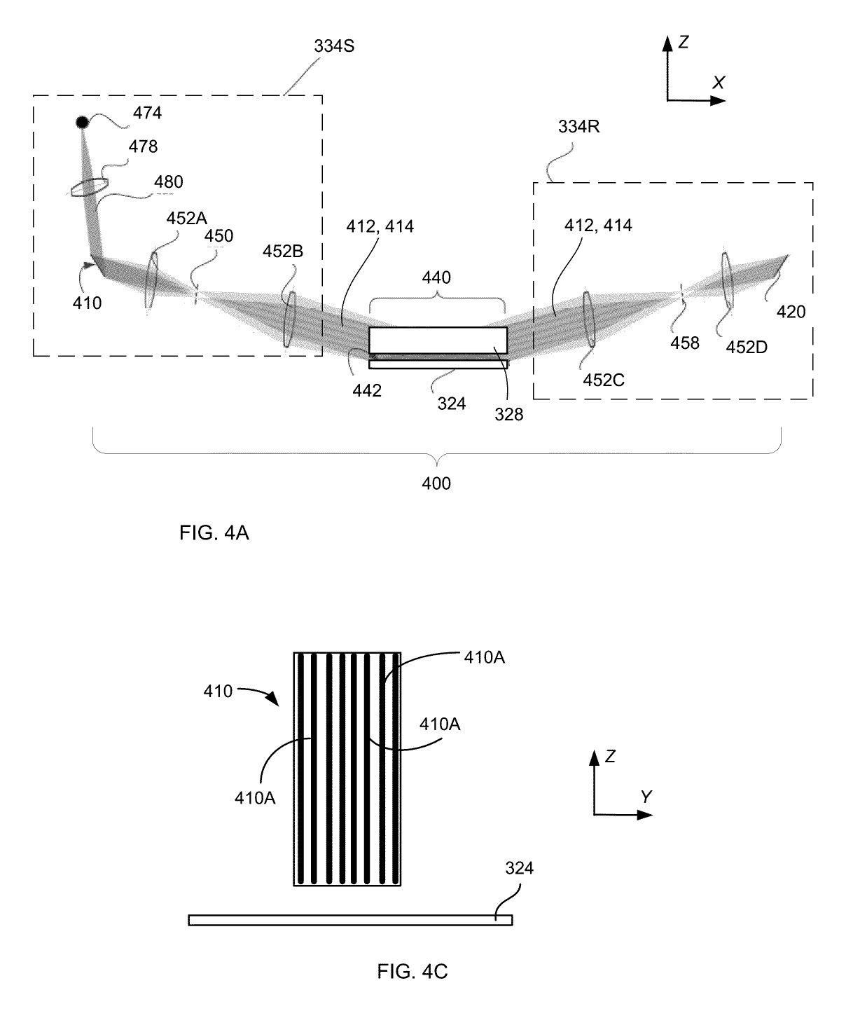

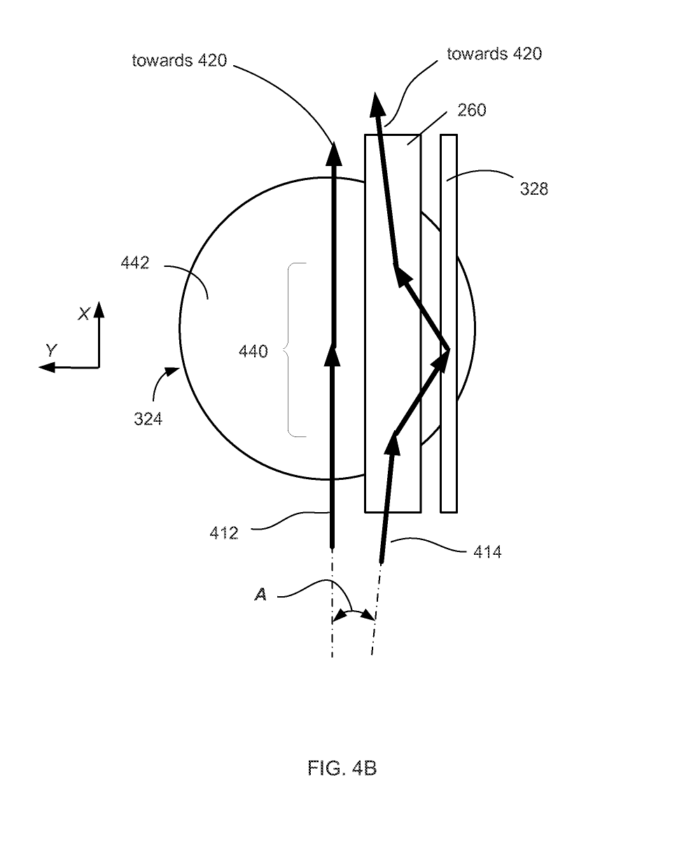

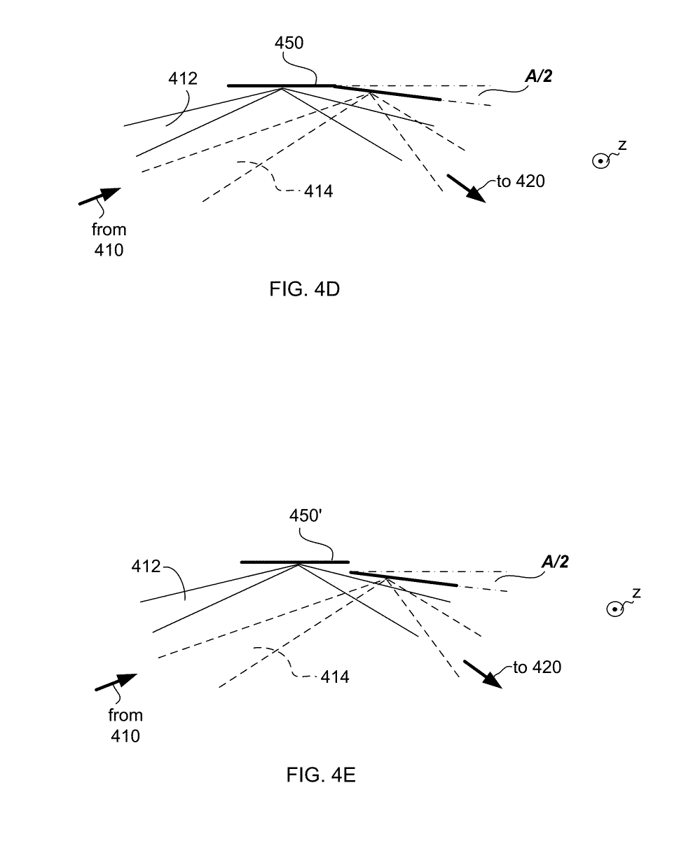

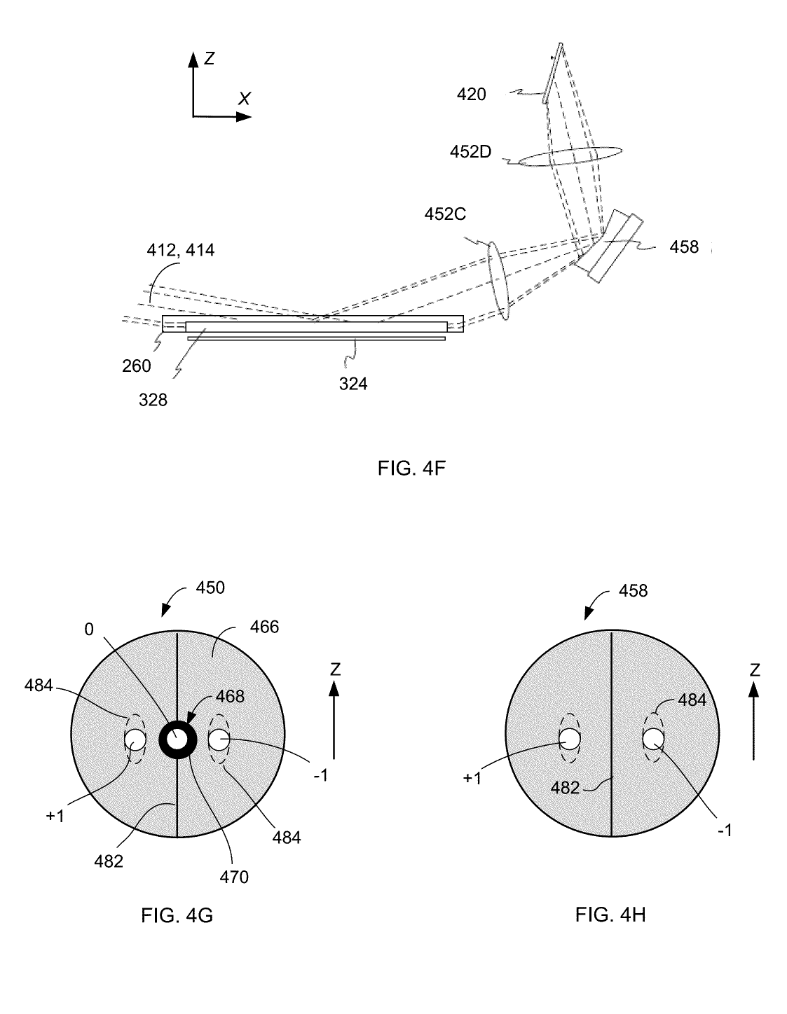

In reference to FIGS. 4A, 4B, 4C, 4D, 4E, 4F, 4G the beamsplitter 410 on the sending side of the specific embodiment 400 of the interferometer of the IAF of the invention is configured to include a diffraction grating positioned such that its grooves (or pattern lines) are nominally perpendicular to the direction of scan of the SUT 324 (i.e., perpendicular to the y-direction of FIG. 4A). Representation of a system in FIG. 4A is very schematic to coarsely illustrate the optical arrangement. While light is shown propagating through the system in reflection through all of the illustrated components, it is understood that generally at least one of the refractive optical components may be substituted with equivalently performing reflective optics.

In one embodiment (not shown), the pattern lines of the diffraction grating are additionally tilted with respect to (that is, are not parallel to) the surface of the SUT 324 being measured. The grating 410 is structured to form, from light 416 incident thereon, a beam representing +1 order of diffraction, a beam representing −1 order of diffraction and, generally the zeroth order of diffraction can be present as well. The embodiment 400 is judiciously structured such as (i) to direct only one of the +1 and −1 order diffracted beams into the sample arm of the interferometer, and (ii) to direct only another one of +1 and −1 diffraction orders into the reference arm of the interferometer such that no light from the sample arm leaks into the reference arm and vice versa. In this case, only light from one of the diffraction orders (+1 as shown) formed by the grating interacts with the SUT 324, forming a foot-print 440 on the working surface 442, while only light from another of the diffraction orders (−1 as shown) formed by the grating interacts with the reference reflector 328.

To introduce a positional difference between the +1 and −1 diffraction order beams 412, 414 on their propagation, the auxiliary optics is used. Such auxiliary optics may include, on the sending side 334S, a spatial filter 450 can be structured from two surfaces the extensions of which form a dihedral angle (that is, which are inclined with respect to one another) and each of which intercepts only one of the beams 412, 414, respectively, while not intercepting another. For example, such spatial filter 450 may include a judiciously positioned multi-faceted mirror or prism forming a roof and a roof edge, configured in a fashion similar to that schematically shown in FIG. 4D, where the sample beam 412 is shown in solid lines and the reference beam 414 is shown in dashed lines. FIG. 4E illustrates a modified version of the filter in which the multi-faceted mirror 450′ is shown to include two individual mirrors that are slightly offset along a direction of the wafer scan. In addition, the spatial filter 450 (on the sending side of the interferometer 400) is configured to block light contained in the zeroth order of diffraction such that only beams 412, 414 continue to propagate towards the receiving side 334R of the embodiment 400 (by, for example, absorbing it directly at the spatial filter, or having the zeroth order pass through an aperture made in the spatial filter towards an absorber positioned behind the filter; not shown).

In a specific case, wavefront-curvature-changing optical components 452A, 452B (such as for example, lenses or, in a different implementation, curved mirrors) may be employed to ensure that both the sample and reference beams 412, 414 are collimated upon interacting, respectively, with the SUT 324 and the reference reflector 328. In this specific case, the first spatial filter 450 may be disposed in a surface containing the points at which the sample and reference beams 412, 414 converge prior to reaching the SUT 324 and the reference reflector 328, respectively.

Referring further to FIG. 4A, the beams 412, 414 continue to propagate without overlapping with one another, along the sample and reference arms of the interferometer 400, respectively, towards the beam combiner 420 positioned on the receiving side. The beam combiner 420 in this embodiment includes an optical detector, on the face of which the sample and reference beams 412, 414 are made overlap to form interference fringes detected by the optical detector of the beam combiner 420. To achieve such overlap, a second spatial filter 458 can be used, which is structured substantially in the same fashion as that of the first spatial filter 450 (discussed below) to bring these beams together only in the plane of the optical detector of the beam combiner 420.

When the collimating optics 452A, 452B are used on the sending side 334S of the embodiment 400, the reciprocal use of the collimating optics 452C, 452D on the receiving side 334R may be preferred. An example of implementation of the receiving side 334R that employs a multifaceted reflector 458 is shown in FIG. 4F.

FIGS. 4G and 4H schematically illustrate specific embodiments of the spatial filters 450 and 458, respectively, with reflective surface(s) 466 and a through-hole 468 in the surface of the filter 450, behind which an absorber 470 is placed. Spots marked +1; 0; −1 indicate cross-sections of diffracted beams incident onto (optionally, converging at) a given filter. These spots correspond to +1, zeroth, and −1 orders of diffraction on the grating 410, respectively, when a light source 474 that can be used to illuminate the grating 410 through the optional optical component 478 generates substantially monochromatic light 480. In case of a polychromatic (for example, broad-band) illumination of the grating 410, the distribution of light on the surfaces of filters 450, 458 could be extended along the z-axis (along an edge 482 of the filters, as schematically shown with dashed contours 484) as well as along an axis transverse to the z-axis (for example, along the y-axis). One end of each of such polychromatic distribution of irradiance corresponds to one end of the spectrum of light 480, while another end corresponds to another end of the spectrum of light 480. It is understood, that if the spectrum of light 480 is not continuous but polychromatic, the distribution of light on the surface(s) 466 may be spatially discontinuous as well, under some circumstances.

It is appreciated, that the beamsplitter 410 defines the first ends (i.e., the beginnings) of both the sample and reference arms of the interferometer 400, while the beam combiner 420 defines the second ends of both arms. It is also appreciated that, in contradistinction with the related art utilizing the FP-AFS, in this embodiment the beams corresponding to different diffraction orders formed by the grating are displaced with respect to one another in a plane parallel to the wafer under test.

### Example 2

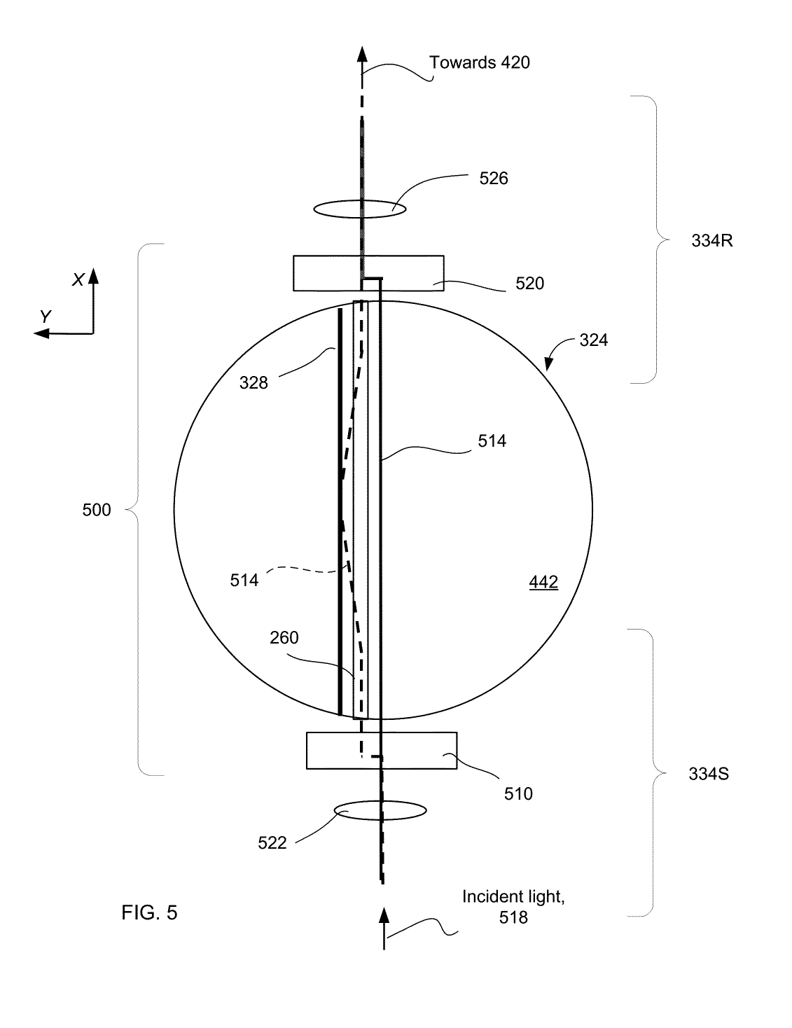

A related embodiment 500 of the interferometer device is schematically shown in FIG. 5, and is configured for use in a level sensor or an autofocus system. As shown, incident light delivered as a collimated beam from a light source is split, with the use of an optical component 510 on the sending side 334S of the embodiment, into sample and reference beams 512, 514. The directions of propagation of such sample and reference beams 512, 514 are angularly deviated from one another. The beams are respectively directed to a work piece (SUT) 324 and the reference reflector 328 such as to form respective foot-prints on the surface 442 and the surface of the reflector 328. The optical component 510 may be a judiciously chosen prism or a combination of prisms (to operate in transmission) or an appropriate combination of reflecting surfaces (to operate in reflection). It is appreciated that the foot-prints formed by the sample and reference beams 512, 514 are continuously and substantially-equally extended in a direction perpendicular to the direction of wafer scan (due to the grazing incidence on the corresponding surfaces). The optical system of the embodiment 500 is substantially symmetrical, in that the optical component 520, disposed across the sample and reference beams that have been reflected by the elements, 324, 328, is configured in a fashion similar to that of the component 510 to bring the sample and reference beams together to propagate in the same direction and along the same line by removing the angular deviation between these beams; the collimating optic 522 on the sending side 334S has a reciprocal collimating optic 526 on the receiving side 334R.

When the light generated for use in the level sensor is polychromatic, preceding the collimating optic 522 there may be positioned a dual-function filter (not shown) filtering the light incident thereon from the light source both spectrally and spatially. Such dual-function filter may include, for example a combination of diffraction grating or prism (not shown) with an auxiliary element. In case of the grating, such grating is configured with its grooves being parallel to the direction of wafer scan to generate at least one order of diffraction at each wavelength of light incident thereon, and complemented with a blocker/absorber that is positioned to block/absorb any generated diffraction order but one (for example, a +1 order of diffraction) at each of the wavelengths. In this case, the remaining order at each wavelength, that is passed by the dual function filter, arrives at the collimating optic 514 as beam 518 and is further incident on the wafer 324 at a respectively corresponding angle that is wavelength-dependent. Such structure is devoid of a second diffraction grating on the receiving side 334R of the system.

It is appreciated that an interferometer of the invention (such as any of the interferometers 400 and 500) is dimensioned such that not only the optical path difference between the sample and reference beams (412, 414 o4 512, 514) is no greater than the coherence length of incident light, but that such optical path difference is minimal and such that the sample and reference beams experience (upon traversing the interferometer) similar if not identical perturbations in phase (due to the change in environmental characteristics, for example) to interfere with one another. When the beams interfere at the detector (CCD), these substantially equal phase changes cancel out and, as a result, the influence of causes of phase perturbations upon propagation of light does not affect the results of the measurement. In other words, the interferometric phase determined based on the data representing the interference fringes detected by the CCD 420 directly represents the difference in topography between the reference reflector and the surface of the SUT.

The spatial pitch of the fringes in the plane of the detector 420 provide little—if any—effect on the sensitivity of the measurement to the z-profile (height profile) of the wafer 324, as long as the spatial pitch of the fringes is small enough such that there is at least 2π of phase across the y extent of the detector 420. As the wafer is scanned along the y-direction, any reflectance or phase variations associated with the surface of the wafer is be traced through the full 2 range of phase, as reflected by interference fringes at the plane 420. Therefore, if the data that represent the wafer height-profile are calculated, by the processor, based on the measurement data acquired as a function of the change in y-position of the wafer and synchronized in time with the wafer motion, then the relief pattern and any position-dependent change of reflectance on the surface of the wafer also do not cause errors in the measurement.

In a FP-measurement modality of the related art, the sensitivity of the measurement system to changes of level along the z-axis is effectuated, at least in part, by a particular pitch of the grating grooves and the large angle of incidence of light onto the wafer (as measured with respect to the normal to the wafer). In contradistinction, in the present invention of IAF, the z-sensitivity is achieved based at least in part on a smaller angle of incidence of light onto the wafer and the wavelength of used light. The axial sensitivity of the measurement (along a line normal to the wafer's surface) can be expressed, in radians of fringe phase per micron of wafer motion, as follows:

$${S}_{Z} ( rad \text{/} µm ) = Δ z * k * \frac{2 π}{λ} cos θ , \qquad Eq . ( 1 )$$

where Δz=1 μm, θ is the angle of incidence of the measurement beam onto the surface of the wafer, and k=2 due to the system operating in reflection of light from the wafer.

In order to increase the value of S_{Z}, the wavelength and/or the angle of incidence should be reduced. It is appreciated that the reduction of the angle of incidence of light onto the wafer is associated, generally, with increase of the aperture of the lens(es) needed to measure, simultaneously, a large x-extended region on the wafer. In a particular example, assuming D is an x-extent of the foot-print of sample beam on the wafer, the minimum size of the lens LS can be assessed according to

LSₘᵢₙ=D cos θ Eq. (2)

The calculation shows that, for particular geometry such as for θ=77.5° and D=120 mm, LSₘᵢₙ is about 26 mm and S_{Z} is about 6.5 radians per μm of wafer height. (The values of and D can vary in practice, as understood by a skilled artisan. For example, the value of D may be between about 50 mm and the full diameter of the wafer, such as 300 mm or 450 mm, depending on the wafer). By comparison, the FP-AFS of related art (in which θ=86°) has a sensitivity of about 0.3 rad/μm, so the use of the present invention increases the z-sensitivity by a factor of about 22.

### Example 3

### Embodiment with Reduced Sensitivity to Changes in Spectrum of Light

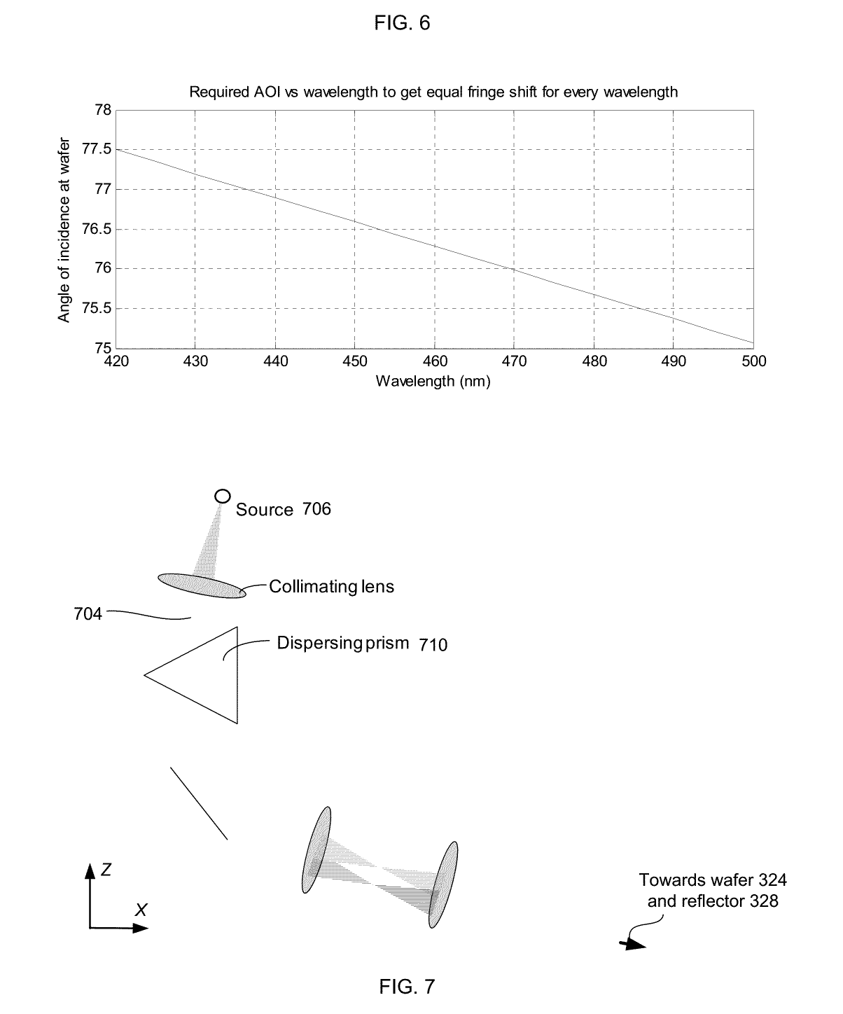

Since the phase associated with a given interferometric fringe at the plane of the detector 420 is wavelength-dependent, it is appreciated that, when a light source used with the embodiment of the present invention is a polychromatic source generating light at multiple wavelengths (for example, a superluminescent laser diode), the contrast of the interferometrically formed distribution of light in plane 420 varies with the change of the z-position of the wafer 324 and may, under some conditions, drop precipitously. FIG. 6 provides a plot illustrating angles of incidence (AOIs) at which light at different wavelengths (shown within the range from 420 nm to 500 nm) should be incident onto the wafer 324, that has been disposed into the sample arm of the interferometer of the invention, in order for interference fringes formed at these wavelengths to spatially shift (as a function of z-shift of the wafer) by the same amount. In other words, provided that light output from a broadband source is made to impinge on the wafer under test, in an embodiment of the present invention, at angles that are chosen according to the light-source wavelength distribution, the axial sensitivity of the measurement with the use of such embodiment will be substantially non-susceptible to the change of spectral content of light. The required optical arrangement can be based on the use of a spectrally-dispersing optical component (such as a prism-based component, for example) positioned in the illumination system used with the embodiment of the interferometer of the invention. An embodiment of the “sending-side” of such contraption is schematically shown in FIG. 7, where prism dispersing light 704 from a broadband (polychromatic) light-source 706 is denoted as element 710. The determination of the z-profile of the wafer 324 becomes straightforward then, based on the direct conversion of a phase figure (determined from data representing interferometric fringes in the plane of optical detector 420) to the wafer height.

Furthermore, with the use of the present embodiment characterized by sensitivity that is wavelength-independent, the measurement of the z-profile of the wafer is decoupled from and unaffected by the presence of environmental changes (such as air turbulence along an optical path of the interferometer); the system can be designed in such a way as to eliminate the air turbulence errors as explained in detail in commonly-owned U.S. patent application Ser. No. 14/480,810, the disclosure of which is incorporated herein by reference. Indeed, if the sensitivity of the measurement to changes in z is substantially the same for measurements performed at different wavelengths (as mentioned above in reference to FIG. 6), then the phase change for each wavelength for a given z change is the same, and the teachings of the abovementioned application can be applied: Since the sensitivity to air turbulence of a measurement performed at given wavelength depends directly on the wavelength, but z-sensitivity does not depend on wavelength, then, for two measurements of the wafer effectuated at a corresponding one of two different mean angles of incidence, the influence of the air turbulence on the experimental data can be directly measured and, therefore, removed from the consideration by appropriately defining a system of two equations with two unknowns.

As was already alluded to above, the light source used with the invention should preferably be such that a coherence length of light it generates is no smaller than the OPD between the sample and reference beams of the invention. In addition, with the grazing angle of incidence, the x-position (i.e., the position along a direction that is perpendicular to the direction of the wafer scan) of the sample beam changes rather quickly in response to a change in the z-position of the wafer, while the reference beam remains fixed (which is in contradistinction with the principle of operation of a fringe-projection AFS of related art). A ‘point’-like source of light (for example that provided by a monochromatic light output, with a dimension on the order of several microns, from a single mode fiber into which light from the superluminescent laser diode is coupled), would work very well due to the substantial spatial coherence of such light. In comparison, monochromatic light from a ‘large’ source (for example, having a dimension on the order of 1 mm) has smaller spatial coherence. If we have a ˜4.5 um source (single mode fiber), then any part of the beam can be made to interfere with any other part, within reason; increased spatial coherence.

It is appreciated that light interacting with a wafer-under-test in an embodiment of the invention experiences Goos-Hanchen (GH) shift(s). In one implementation of the present invention, the compensation of such phase shifts is effectuated by employing the teachings of the commonly-assigned U.S. patent application Ser. No. 14/302,187, the disclosure of which incorporated by reference herein. It is anticipated that the GH effect phase shift(s) present, during the operation of an embodiment of this invention is about the same order of magnitude (characterized by substantially similar change in beam phase) as that in embodiments of the FP-AFS of related art. The extent to which the GH effect affects measurement errors depends on whether the GH-shift-caused errors are larger or smaller than errors caused by changes in wafer height. In example(s) of the interferometric AF system of the present invention, the phase effect of the wafer height change was shown to be at least an order of magnitude (roughly 22 times) larger than that in the related art. Therefore, the relative magnitude of measurement errors caused by the GH shift can be expected to be smaller than that in related art.

For the purposes of this disclosure and the appended claims, the use of the term “substantially” as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. The use of this term in describing a chosen characteristic or concept neither implies nor provides any basis for indefiniteness and for adding a numerical limitation to the specified characteristic or descriptor. For example, a reference to a vector or line being substantially parallel to a reference line or plane is to be construed as such vector or line extending along a direction or axis that is the same as or very close to that of the reference line or plane (for example, with angular deviations from the reference direction or axis that are considered to be practically typical in the art). As another example, the use of the term “substantially flat” in reference to the specified surface implies that such surface may possess a degree of non-flatness and/or roughness that is sized and expressed as commonly understood by a skilled artisan in the specific situation at hand.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

In addition, it is to be understood that no single drawing is intended to support a complete description of all features of the invention. In other words, a given drawing is generally descriptive of only some, and generally not all, features of the invention. A given drawing and an associated portion of the disclosure containing a description referencing such drawing do not, generally, contain all elements of a particular view or all features that can be presented is this view, for purposes of simplifying the given drawing and discussion, and to direct the discussion to particular elements that are featured in this drawing. A skilled artisan will recognize that the invention may possibly be practiced without one or more of the specific features, elements, components, structures, details, or characteristics, or with the use of other methods, components, materials, and so forth. Therefore, although a particular detail of an embodiment of the invention may not be necessarily shown in each and every drawing describing such embodiment, the presence of this detail in the drawing may be implied unless the context of the description requires otherwise. In other instances, well known structures, details, materials, or operations may be not shown in a given drawing or described in detail to avoid obscuring aspects of an embodiment of the invention that are being discussed. Furthermore, the described single features, structures, or characteristics of the invention may be combined in any suitable manner in one or more further embodiments.

An embodiment of the interferometric autofocus system of the invention includes electronic circuitry (for example, a computer processor) controlled by instructions stored in a memory, to perform specific data collection/processing and calculation steps as disclosed above. The memory may be random access memory (RAM), read-only memory (ROM), flash memory or any other memory, or combination thereof, suitable for storing control software or other instructions and data. Those skilled in the art should would readily appreciate that instructions or programs defining the operation of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement a method of the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

The invention as recited in claims appended to this disclosure is intended to be assessed in light of the disclosure as a whole. Disclosed aspects, or portions of these aspects, may be combined in ways not listed above. Accordingly, the invention should not be viewed as being limited to the disclosed embodiment(s).

What is claimed is:

1. An autofocus system (AFS) comprising
an interferometer disposed along an optical path of said AFS, the interferometer having sample and reference arms that correspond, respectively, to optical paths of sample and reference beams of light,
the sample beam of light defined only by first light contained in one order of diffraction of incident light formed at a diffraction grating of the AFS;
the reference beam of light defined only by second light contained in another order of diffraction of said incident light at said diffraction grating.

2. An AFS according to claim 1, configured to measure a position of a work piece, that has been disposed across an optical path of the sample beam of light, along an axis that is orthogonal to a working surface of the work piece, and further comprising one or more of
a light source assembly configured to generate said light incident onto said diffraction grating;
a detector assembly including an optical detector a surface of which is optically conjugate with said diffraction grating through an optical system of the AFS; and
a control system including electronic circuitry programmed to acquire measurement data from said detector assembly and to produce a numerical assessment of a change in said position based on said measurement data.

3. An AFS according to claim 2, wherein said light source assembly is configured to generate light at multiple wavelengths.

4. An AFS according to claim 1, further comprising a surface at which said sample and reference beams spatially overlap for the first time within said AFS, said surface being optically conjugate to said diffraction grating.

5. An AFS according to claim 4, wherein said surface includes a surface of an optical detector, wherein said diffraction grating defines first ends of the sample and reference arms, and wherein said surface of the optical detector defines second ends of the sample and reference arms.

6. An AFS according to claim 1, configured such that, in operation, a work piece is disposed in the sample arm with a target surface of said work piece being inclined at an angle with respect to pattern lines of said diffraction grating, the angle being different from zero.

7. An AFS according to claim 1, further comprising a first spatial filter disposed across the sample and reference beams such as to block a beam defined by the zeroth order of diffraction that has been formed by said diffraction grating in response to light incident thereon,
said first spatial filter including two surfaces forming a dihedral angle,
a first of the two surfaces intercepting said first light and not intercepting said second light,
a second of the two surfaces intercepting said second light and not intercepting said first light.

8. An AFS according to claim 1, wherein each of said two surfaces is a light reflector.

9. An autofocus system (AFS) comprising:
diffraction grating, and
an interferometer that includes
sample and reference arms, each arm having a corresponding first end defined by the diffraction grating and dimensioned
to direct only first light that is contained in one diffraction order, formed by said diffraction grating in response to light incident thereon, into the sample arm, and
to direct only second light that is contained in another diffraction order, that has been formed by said diffraction grating in response to said light incident thereon, into the reference arm.

10. An AFS according to claim 9, further comprising an optical detector disposed to define corresponding second ends of each of said sample and reference arms, each of said arms being defined between said diffraction grating and said optical detector.

11. An AFS according to claim 10, wherein a plane of said optical detector is optically conjugate to a grating plane along which a periodic structure of said diffraction grating extends.

12. An AFS according to claim 9, configured such that, in operation, a work piece is disposed in the sample arm with a target surface of said work piece being inclined at an angle with respect to grooves of said diffraction grating, the angle being different from zero.

13. An AFS according to claim 12, configured such that a first angle is substantially a right angle, said first angle defined as an angle formed between a first line and the target surface, said first line defined as a projection of a groove of the diffraction grating onto a plane that is perpendicular to the second line, said second line defined by a projection of the groove onto the target surface.

14. An AFS according to claim 9, further comprising a first spatial filter disposed across the sample and reference beams to block a beam defined by the zeroth order of diffraction that has been formed by said diffraction grating in response to light incident thereon.

15. An AFS according to claim 14, wherein said first spatial filter includes two reflective surfaces forming a dihedral angle with one another, a first of the two reflecting surfaces intercepting light propagating in the sample arm while not intercepting light propagating in the reference arm, a second of the two reflecting surfaces intercepting light propagating in the reference arm while not intercepting light propagating in the sample arm.

16. An AFS according to claim 14, further comprising a second spatial filter disposed across the sample and reference beams such that the first spatial filter is positioned between said diffraction gratings and said second spatial filter.

17. An AFS according to claim 16, further comprising an optical element configured in both sample and reference arms such as to define points of conversion of said first and second light, and wherein at least one of said first and second spatial filters is disposed at a surface in which said points of conversion are located.

18. An AFS according to claim 9, configured as a part of a system structured to measure a position of a work piece along an axis that is orthogonal to a working surface of the work piece disposed in the sample arm, and further comprising one or more of
a light source assembly configured to generate said light incident onto said diffraction grating;
a detector assembly including an optical detector, a surface of which is optically conjugate with said diffraction grating; and
a control system including electronic circuitry configured to acquire measurement data from said detector assembly and programmed to produce a numerical assessment of a change in said position based on said measurement data, said measurement data representing a change in distribution of interference fringes formed by said sample and reference beams overlapping at said surface of the optical detector in response to said change.

19. A method for operating an autofocus system (AFS), an optical system of the AFS containing an interferometer, the method comprising:
forming first and second optical beams as a result of diffraction of light incident onto a diffraction grating;
transmitting only the first optical beam through a sample arm of the interferometer disposed within the AFS to form a sample optical beam;
transmitting only the second optical beam through a reference arm of said interferometer to form a reference optical beam; and
forming interference fringes by overlapping said sample and reference beams at an optical detector of the AFS.

20. A method according to claim 19, wherein said transmitting only the first optical beam and said transmitting only the second optical beam is devoid of overlapping said first and second optical beams anywhere between the diffraction grating and the optical detector.

21. A method according to claim 19, wherein any of said transmitting only the first optical beam and transmitting only the second optical beam includes transmitting light through said interferometer having first and second ends, the first end defined by said diffraction grating, the second end defined by said optical detector.

22. A method according to claim 19, further comprising
reflecting said first optical beam with one facet of a multi-faceted reflector, and
reflecting said second optical beam with another facet of said multi-faceted reflector.

23. A method according to claim 19, further comprising
reflecting said sample beam with a work-piece disposed in the sample arm, the work piece having a surface being measured with the AFS, and
reflecting said reference beam with a reflecting surface of a side reflector disposed in the reference arm, said reflecting surface oriented transversely with respect to the surface being measured with the AFS.
